(19) United States
(12) Patent Application Publication
(10) Pub. No.: US 2015/0264568 A1
(43) Pub. Date: Sep. 17, 2015

(54) INFORMATION PROCESSING TERMINAL, DATA TRANSFER MEHTOD, AND INFORMATION PROCESSING SYSTEM

(71) Applicant: Kabushiki Kaisha Toshiba, Tokyo (JP)

(72) Inventor: Tokuji Kano, Zushi Kanagawa (JP)

(21) Appl. No.: 14/466,085

(22) Filed: Aug. 22, 2014

(30) Foreign Application Priority Data
Mar. 14, 2014 (JP) 2014-041949

(51) Int. Cl. H04W 12/06; H04W 4/00

(52) U.S. Cl. CPC H04W 12/06; H04W 4/008

(57) ABSTRACT

According to an embodiment, an information processing terminal includes a close proximity wireless communication unit configured to transfer data to a mobile terminal that is placed within a predetermined distance, using a close proximity wireless transfer technique, a data unit configured to store the data to be transferred to the mobile terminal, a user specifying unit configured to identify an authorized user by using user specification information of the mobile terminal, and a data difference determination unit configured to determine a difference between the data stored in the mobile terminal and the data stored in the data unit.

### CROSS-REFERENCE TO RELATED APPLICATION

This application is based upon and claims the benefit of priority from the Japanese Patent Application No. 2014-41949, filed on Mar. 14, 2014; the entire contents of which are incorporated herein by reference.

### FIELD

An embodiment described herein relates generally to an information processing terminal, a data transfer method, and an information processing system.

### BACKGROUND

In recent years, sophistication of functionality of mobile terminals is progressing so that a network service may be enjoyed at a high speed and with a high image quality, or various service contents may be executed. To realize the sophistication of functionality, an operating system (hereinafter referred to also as OS) installed on the mobile terminal is also progressing from day to day, and new versions and new OSs are released ever more frequently.

Also, applications for providing various services to users are also progressing from day to day, and new applications for receiving new services are downloaded and installed in the mobile terminal more frequently, and new versions of applications already in use are downloaded and the applications are updated more frequently.

In the case of downloading an OS or an application to a mobile terminal, conventionally, the telephone network of the mobile terminal or the wireless LAN network of the mobile terminal was used to download necessary files. However, as described above, frequency of download of OSs and applications is on the increase, and also, the data amount of OS files and application files is increased due to the sophistication of functionality of the OSs and the applications, and thus, there is a problem that download may take a long time when using the wireless telephone network or the wireless LAN.

### BRIEF DESCRIPTION OF THE DRAWINGS

FIG. 1 is a schematic block diagram showing a structure of an information processing terminal 1 according to an embodiment of the present invention;

FIG. 2 is a diagram describing an example of a structure of a file stored in a data unit 6; and

FIG. 3 is a flowchart describing a procedure of downloading data from the information processing terminal 1 to a mobile terminal 21.

### DETAILED DESCRIPTION

An information processing terminal according to an embodiment includes a close proximity wireless communication unit configured to transfer data to a mobile terminal that is placed within a predetermined distance, using a close proximity wireless transfer technique, a data unit configured to store the data to be transferred to the mobile terminal, a user specifying unit configured to identify an authorized user by using user specification information of the mobile terminal, and a data difference determination unit configured to determine a difference between the data stored in the mobile terminal and the data stored in the data unit.

### Embodiment

In the following, an embodiment will be described with reference to the drawings.

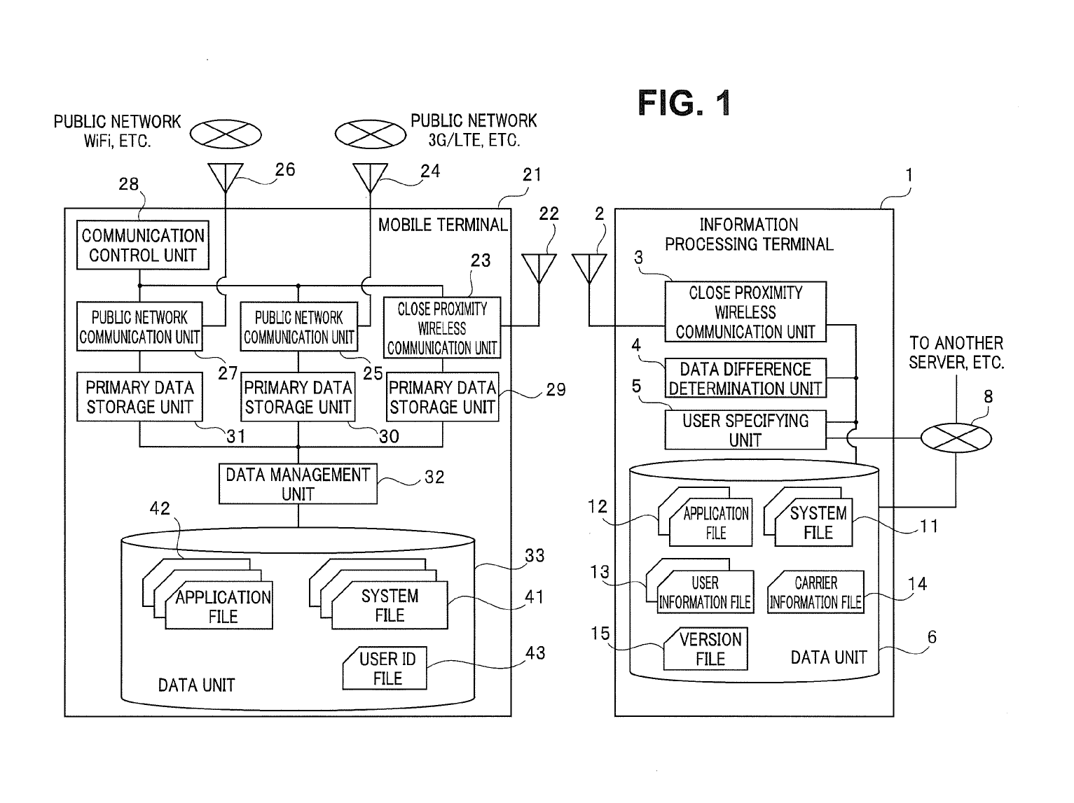

FIG. 1 is a schematic block diagram for describing a structure of an information processing terminal according to an embodiment of the present invention. As shown in FIG. 1, an information processing terminal 1 of the present embodiment includes a close proximity wireless communication unit 3 for performing close proximity wireless communication with an external mobile terminal 21 and the like, a data unit 6 for storing various types of data, a data difference determination unit 4 for calculating a difference between data stored in the data unit 6 and data received via the close proximity wireless communication unit 3, and a user specifying unit 5 for checking whether or not the user of the mobile terminal 21 with which close proximity wireless communication is being performed is an authorized user, and for checking whether or not an OS or an application installed in the mobile terminal 21 is that of the authorized user.

When the mobile terminal 21 having a close proximity wireless communication function is placed within a predetermined distance from the information processing terminal 1, the close proximity wireless communication unit 3 establishes a wireless connection to the mobile terminal 21, and performs transmission/reception of data. Communication between the information processing terminal 1 and the mobile terminal 21 is performed by peer-to-peer close proximity wireless communication using TransferJet™, for example. TransferJet™ is a close proximity wireless method using ultra wide band (UWB), and data transfer may be performed at a higher speed compared to wireless communication of performing audio or data (packet) communication via a base station of a carrier for 3G, LTE or the like, or wireless communication of performing data communication via a wireless LAN router for WiFi or the like.

A close proximity wireless communication antenna 2 is connected to the close proximity wireless communication unit 3. The close proximity wireless communication antenna 2 is not a conventional antenna that uses a radiation electromagnetic field, and is structured from a coupler device that uses an induction field. When a close proximity wireless communication antenna 22 of the mobile terminal 21 and the close proximity wireless communication antenna 2 of the information processing terminal 1 come close to within a communication range (for example, about 3 cm), the antennas 2 and 22 are coupled by electromagnetic induction. Wireless communication between the information processing terminal 1 and the mobile terminal 21 is thereby enabled.

The data unit 6 stores file data (hereinafter referred to as a file) related to various OSs and applications that is installable and executed by the mobile terminal 21, and management data for the files. As the files that may be executed by the mobile terminal 21, an operating system file (hereinafter referred to as a system file) 11, and an application file 12 for execution of various applications related to video, music, game, dictionary, weather forecast, and position information search service are stored, for example. As the management data, a version file 15 for managing version information of the system file 11 and the application file 12 stored in the data unit 6, a user information file 13 for managing information about an authorized user allowed to use the system file 11 and the application file 12, and a carrier information file 14 for managing information about an authorized user allowed to use the mobile terminal 21 that is to communicate with the information processing terminal 1 are stored, for example. These files 11 to 15 are acquired as necessary from a predetermined external server or the like connected to the information processing terminal 1 through a network 8, and are stored in the data unit 6.

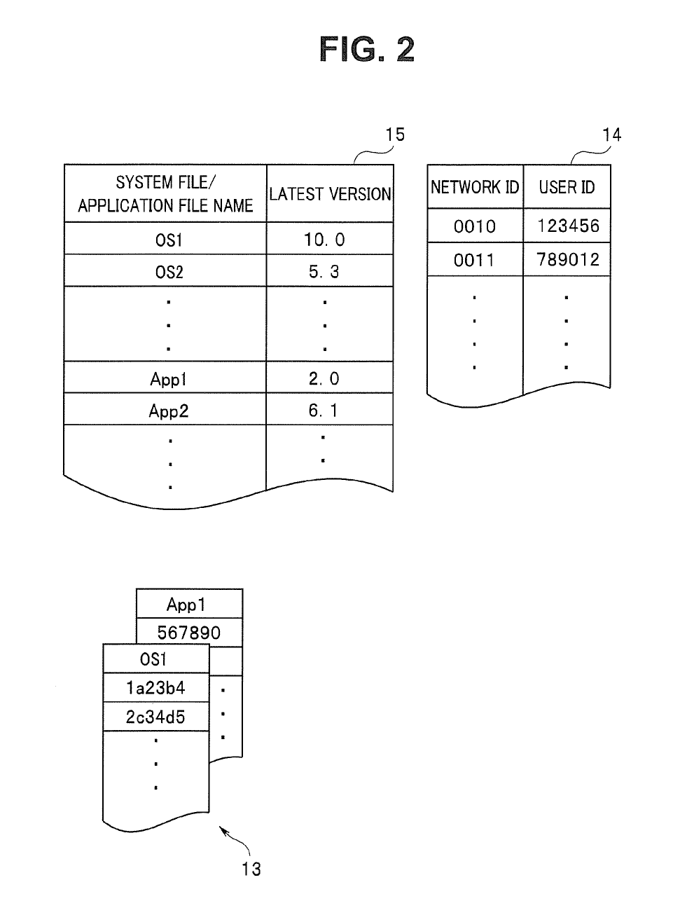

The concrete structure of a file stored in the data unit 6 will be described with reference to FIG. 2. FIG. 2 is a diagram describing an example of the structure of a file stored in the data unit 6. Note that, with respect to the system file 11 and the application file 12, the format and the structure are different depending on the function or the like of the OS or the application, and a concrete description thereof is omitted.

In the version file 15, a system file name/application file name and the latest version of each file are associated with each other, and are shown in a table format as shown in FIG. 2, for example. Note that only the latest version is described for each file in the example shown in FIG. 2, but all the versions stored in the data unit 6 may be described together instead. Also, the system file and the application file may be described in separate tables.

In the user information file 13, IDs (authorized user IDs) enabling identification of authorized users allowed to use (download) the file are listed for each OS or application. For example, as shown in FIG. 2, one list is prepared for each OS or each application, and IDs of authorized users allowed to use the file is included in each list. Note that, instead of creating separate lists for respective OSs and applications, the authorized user IDs for all the OSs and applications may be described in one table. It is also possible to use two tables, a table describing the authorized user IDs of the OS and a table describing the authorized user IDs of the application, for example.

In the carrier information file 14, a network ID registered in advance, by the authorized user of the mobile terminal 21 that is to perform communication, for the carrier of the mobile terminal 21, and an ID for uniquely identifying the authorized user are associated with each other, and are shown in a table format as shown in FIG. 2. Note that the carrier information file 14 does not necessarily have to be stored in the data unit 6, and an inquiry may be made to a predetermined external server (a server of the carrier of the mobile terminal 21) connected via the network 8 when checking of a network ID and a user ID is necessary.

Next, the structure of the mobile terminal 21 capable of establishing a wireless connection to the information processing terminal 1, and of downloading a file from the information processing terminal 1 will be described with reference to FIG. 1. As shown in FIG. 1, the mobile terminal 21 includes a close proximity wireless communication unit 23 for performing close proximity wireless communication with the information processing terminal 1, a primary data storage unit 29 for temporarily storing data downloaded via the close proximity wireless communication unit 23, and a data unit 33 for storing various types of data to be used by the mobile terminal 21. The mobile terminal 21 also includes a public network communication unit 25 for performing wireless communication using a public network such as 3G or LTE, and a public network communication unit 27 for performing wireless communication using a wireless LAN such as WiFi. The close proximity wireless communication antenna 22 is connected to the close proximity wireless communication unit 23.

Furthermore, wireless antennas 24 and 26 are connected to the public network communication units 25 and 27, respectively. The wireless antennas 24 and 26 are structured from conventional antennas that use a radiation electromagnetic field. Like the close proximity wireless communication antenna 2 of the information processing terminal 1, the close proximity wireless communication antenna 22 is structured from a coupler device that uses an induction field. Accordingly, when the mobile terminal 21 is placed within a predetermined distance from the information processing terminal 1, the close proximity wireless communication antennas 2 and 22 are coupled by electromagnetic induction, and high-speed wireless communication between the information processing terminal 1 and the mobile terminal 21 is enabled.

In the case of the example shown in FIG. 1, the mobile terminal 21 uses three communication networks of close proximity wireless communication that uses the close proximity wireless communication unit 23, wireless communication such as 3G or LTE that uses the public network communication unit 25, and communication by a wireless LAN such as WiFi that uses the public network communication unit 27. Accordingly, the mobile terminal 21 is provided with a communication control unit 28 for performing control of communication with an external appliance, such as selection of a communication unit for performing transmission/reception of data.

The mobile terminal 21 includes a primary data storage unit 30 for temporarily storing data downloaded via the public network communication unit 25, a primary data storage unit 31 for temporarily storing data downloaded via the public network communication unit 27, and a data management unit 32 for collectively managing transmission/reception of data between the data unit 33 and the three primary data storage units 29, 30, and 31.

The data unit 33 stores various files that are executable at the mobile terminal 21, and files for managing various types of information. More specifically, for example, a system file 41 related to the OS, an application file 42 for execution of various applications related to video, music, game, dictionary, weather forecast, and position information search service, and a user ID file 43 in which user IDs for the OS and various applications used by the mobile terminal 21 are recorded are stored. The versions of the system file 41 and the application file 42 are upgraded as appropriate, and thus, the latest file is acquired as appropriate from the information processing terminal 1 through the close proximity wireless communication unit 23, and the target file in the data unit 33 is updated. Furthermore, also in the case of installation of a new application or OS, a desired file is acquired as appropriate from the information processing terminal 1 through the close proximity wireless communication unit 23, and is stored in the data unit 33.

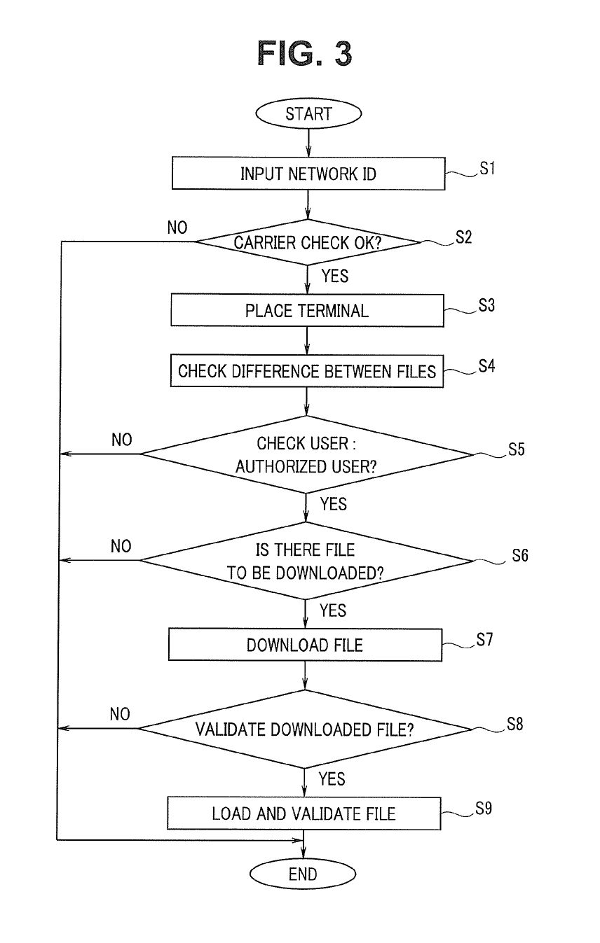

Next, a method for downloading data from the information processing terminal 1 structured in the above manner to the mobile terminal 21 that is connected in a close proximity wireless manner will be described with reference to FIG. 3. FIG. 3 is a flowchart describing a procedure of downloading data from the information processing terminal 1 to the mobile terminal 21.

First, in step S1, a user who wants to download data from the information processing terminal 1 is made to input the network ID. Input of a network ID is performed by an input unit (not shown in FIG. 1) or the like provided to the information processing terminal 1.

Next, in step S2, whether or not the network ID which has been input is present in the carrier information file 14 stored in the data unit 6 is checked (authentication of network ID). In the case the network ID which has been input is not present in the carrier information file 14 (step S2, No), the user is recognized not to be an authorized user registered with the carrier, and the process is ended without downloading data. Note that, in the case where the network ID which has been input is not present in the carrier information file 14, instead of immediately ending the process, an error message may be displayed on a display unit, not shown, and the process may return to step S1 to encourage input of a network ID again. In this case, the process is ended without downloading data when authentication of the network ID fails a predetermined number of times such as three times.

In the case where the network ID which has been input is present in the carrier information file 14 (step S2, Yes), the user is recognized to be an authorized user registered with the carrier, and access to the data unit 6 of the information processing terminal 1 and the server of the carrier from the information processing terminal 1 through the network 8 is allowed. When access is allowed, a message is displayed on the display unit, not shown, of the information processing terminal 1 or audio guidance is presented so as to encourage placement of the mobile terminal 21 at a predetermined position where close proximity wireless communication with the information processing terminal 1 is enabled. The user places the mobile terminal 21 at the predetermined position according to the display or the audio guidance (step S3). Then the close proximity wireless communication antenna 2 of the information processing terminal 1 and the close proximity wireless communication antenna 22 of the mobile terminal 21 are coupled by electromagnetic induction, and high-speed close proximity wireless communication between the information processing terminal 1 and the mobile terminal 21 is enabled. In each of the steps below, transmission/reception of data between the information processing terminal 1 and the mobile terminal 21 is performed using close proximity wireless communication unless specified otherwise.

In the subsequent step S4, the version information of the system file 41 and the application file 42 stored in the data unit 33 of the mobile terminal 21 is read onto the information processing terminal 1. Then, the version information of each of the files 41 and 42 which have been read out is checked at the data difference determination unit 4 using the version file 15 in the data unit 6, and match/non-match is determined. In the case of match, it is determined that the file installed in the mobile terminal 21 is of the latest version, and that the file matches the file stored in the data unit 6 of the information processing terminal 1. In the case of non-match, it is determined that the file installed in the mobile terminal 21 is not of the latest version, and that there is a difference to the file stored in the data unit 6 of the information processing terminal 1. Note that, with respect to the difference check in the present step, the difference may be checked by reading the system file 41 or the application file 42 installed in the mobile terminal 21 onto the information processing terminal 1 and checking the file against the system file 11 or the application file 12 stored in the data unit 6, instead of comparing the versions in the manner described above.

Next, in step S5, whether or not the OS and the application stored in the mobile terminal 21 are that of the authorized user is checked at the user specifying unit 5. First, a user ID registered in association with the OS or each application is read from the user ID file 43 stored in the data unit 33 of the mobile terminal 21 onto the information processing terminal 1. Then, at the user specifying unit 5, the user information file 13 in the data unit 6 corresponding to the OS or the application stored in the mobile terminal 21 is searched, and whether or not the user ID read from the user ID file 43 is present is checked.

For example, it is assumed that an OS “OS1” and an application “App1” are installed in the mobile terminal 21 (that is, the system file 41 related to “OS1” and the application file 42 related to “App1” are stored in the data unit 33), and “1a23b4” is registered in the user ID file 43 as the user ID for “OS1”. It is also assumed that “102340” is registered in the user ID file 43 as the user ID for “App1”. Furthermore, the user information file 13 is as shown in FIG. 2. In this case, in step S5, the user information file 13 related to the OS “OS1” is searched, and it is confirmed that the user ID “1a23b4” is present. That is, the OS “OS1” stored in the mobile terminal 21 is determined to be that of the authorized user. Also, the user information file 13 related to the application “App1” is searched, and it is confirmed that the user ID “102340” is not present therein. That is, the application “App1” stored in the mobile terminal 21 is determined to be that of an unauthorized user.

With respect to an OS and an application for which an unauthorized user is determined, the process is ended without downloading the data (step S5, No). In the example described above, with respect to the application “App1”, the process is ended without downloading the file from the information processing terminal 1. On the other hand, with respect to an OS or an application for which an authorized user is determined, the process proceeds to step S6. In the example described above, the process proceeds to step S6 with respect to the OS “OS1”, and download of the file from the information processing terminal 1 is continued.

In step S6, whether or not there is a file to be downloaded from the information processing terminal 1 to the mobile terminal 21 is determined with respect to the OS or the application for which an authorized user is determined. In this step, the execution result of step S4 performed in advance is referred to, and presence/absence of the file is determined. That is, in the case where it is determined in step S4, with respect to a file related to the target OS or application, that there is no difference between the file stored in the data unit 33 of the mobile terminal 21 and the file stored in the data unit 6 of the information processing terminal 1, it is determined that there is no file to be downloaded (step S6, No). In this case, the process is ended without downloading data.

On the other hand, in the case where it is determined with respect to a file related to the target OS or application that there is a difference between the file stored in the data unit 33 of the mobile terminal 21 and the file stored in the data unit 6 of the information processing terminal 1, it is determined that there is a file to be downloaded (step S6, Yes). In this case, the process proceeds to step S7, and the target file is transmitted, using close proximity wireless communication, from the data unit 6 of the information processing terminal 1 to the primary data storage unit 29 of the mobile terminal 21. For example, in the case where it is determined with respect to the OS “OS1” that there is a difference between the system file 11 stored in the data unit 6 of the information processing terminal 1 and the system file 41 stored in the data unit 33 of the mobile terminal 21, file data which is the difference between the system file 11 and the system file 41 is transmitted, using close proximity wireless communication, from the data unit 6 of the information processing terminal 1 to the primary data storage unit 29 of the mobile terminal 21.

Next, in step S8, the user is asked to select whether or not to validate the downloaded file. In the case where a file related to the OS and a file related to the application, or files related to a plurality of applications are downloaded at the same time, whether or not to validate the file is selected for each OS/application.

In the case where non-validation is selected for all the downloaded files, the process is directly ended (step S8, No). On the other hand, the process proceeds to step S9 for the OS/application for which validation of the file is selected in step S8. In step S9, the file related to the OS/application for which validation is selected is transmitted from the primary data storage unit 29 to the data unit 33, and the version of the OS/application is upgraded by loading and validating the file. In this manner, download of data from the information processing terminal 1 to the mobile terminal 21 is completed by the series of processes from step S1 to step S9.

As described above, according to the present embodiment, since the close proximity wireless communication unit 3 and the close proximity wireless communication antenna 2 are provided to the information processing terminal 1, data may be downloaded, using close proximity wireless communication, to the mobile terminal 21 including the close proximity wireless communication unit 23 and the close proximity wireless communication antenna 22 capable of communicating with the close proximity wireless communication unit 3 and the close proximity wireless communication antenna 2, and data may be downloaded in a short time.

Also, according to the present embodiment, since close proximity wireless communication according to which communication is enabled only when the information processing terminal 1 and the mobile terminal 21 are placed at a very short distance of within several centimeters is used, there is almost no interference with communication of other wireless techniques, and highly confidential information, such as various IDs and passwords, may be communicated by the same route as the data without complicated procedure such as encryption.

Note that, in the example described above, only the file related to the OS/application selected by the user is downloaded from the information processing terminal 1 to the mobile terminal 21, and is loaded/validated, but it is also possible to have files of all the OSs/applications that may be updated to be automatically downloaded from the information processing terminal 1 to the mobile terminal 21 and be loaded/validated when the mobile terminal 21 is placed at a predetermined position where close proximity wireless communication with the information processing terminal 1 is possible. In this case, time required for the series of processes related to download of data may be further reduced.

Each “unit” in the present specification is only a concept corresponding to each function of the embodiment, and does not necessarily correspond one-to-one with specific hardware or software routine. Accordingly, in the present specification, the embodiment is described assuming a virtual circuit block (unit) including each function of the embodiment.

While certain embodiments have been described, these embodiments have been presented by way of example only, and are not intended to limit the scope of the inventions. Indeed, the novel methods and devices described herein may be embodied in a variety of other fauns; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. An information processing terminal comprising:
a close proximity wireless communication unit configured to transfer data to a mobile terminal that is placed within a predetermined distance, using a close proximity wireless transfer technique;
a data unit configured to store the data to be transferred to the mobile terminal;
a user specifying unit configured to identify an authorized user by using user specification information of the mobile terminal; and
a data difference determination unit configured to determine a difference between the data stored in the mobile terminal and the data stored in the data unit.

2. The information processing terminal according to claim 1, wherein the data is file data necessary for execution of an operating system or an application that is installable in the mobile terminal, and the user specifying unit identifies whether or not a license is granted to the operating system or the application installed in the mobile terminal.

3. The information processing terminal according to claim 1, wherein selection of whether or not to validate the data transferred to the mobile terminal using the close proximity wireless communication unit is enabled, and only the data for which validation is selected is loaded and validated.

4. The information processing terminal according to claim 2, wherein the data unit stores the file data, and a version file for management of a version of the operating system or the application related to the file data.

5. The information processing terminal according to claim 4, wherein the data difference determination unit compares the version of the operating system or the application stored in the mobile terminal and the version of the operating system or the application managed by the version file.

6. The information processing terminal according to claim 2, wherein selection of whether or not to validate the data transferred to the mobile terminal using the close proximity wireless communication unit is enabled, and only the data for which validation is selected is loaded and validated.

7. The information processing terminal according to claim 6, wherein the data unit stores the file data, and a version file for management of a version of the operating system or the application related to the file data.

8. The information processing terminal according to claim 7, wherein the data difference determination unit compares the version of the operating system or the application stored in the mobile terminal and the version of the operating system or the application managed by the version file.

9. A data transfer method comprising:
identifying an authorized user with respect to a mobile terminal that is placed within a predetermined distance from an information processing terminal, by using user specification information of the mobile terminal;
determining, as difference data, a difference between data stored in the mobile terminal and data stored in a data unit of the information processing terminal; and
transferring the difference data from the information processing terminal to the mobile terminal using a close proximity wireless transfer technique.

10. The data transfer method according to claim 9, wherein the data is file data necessary for execution of an operating system or an application that is installable in the mobile terminal.

11. The data transfer method according to claim 10, wherein whether or not a license is granted to the operating system or the application installed in the mobile terminal is identified.

12. The data transfer method according to claim 9, wherein selection of whether or not to validate the difference data transferred to the mobile terminal using the close proximity wireless communication technique is enabled, and only the difference data for which validation is selected is loaded and validated.

13. The data transfer method according to claim 10, wherein the data unit stores the file data, and a version file for management of a version of the operating system or the application related to the file data.

14. The data transfer method according to claim 10, wherein the version of the operating system or the application stored in the mobile terminal and the version of the operating system or the application managed by the version file are compared.

15. An information processing system comprising:
a mobile terminal in which an operating system or an application is installed;
an information processing terminal including file data necessary for execution of the operating system or the application installed in the mobile terminal,
wherein the information processing terminal includes
a close proximity wireless communication unit configured to transfer the file data to the mobile terminal that is placed within a predetermined distance, using a close proximity transfer technique,
a data unit configured to store the file data to be transferred to the mobile terminal,
a user specifying unit configured to identify an authorized user by using user specification information of the mobile terminal, and
a data difference determination unit configured to determine a difference between the file data stored in the mobile terminal and the file data stored in the data unit.

16. The information processing system according to claim 15, wherein the user specifying unit identifies whether or not a license is granted to the operating system or the application installed in the mobile terminal.

17. The information processing system according to claim 15, wherein selection of whether or not to validate the file data transferred to the mobile terminal using the close proximity wireless communication unit is enabled, and only the file data for which validation is selected is loaded and validated.

18. The information processing system according to claim 16, wherein the data unit stores the file data, and a version file for management of a version of the operating system or the application related to the file data.

19. The information processing system according to claim 16, wherein the data difference determination unit compares the version of the operating system or the application stored in the mobile terminal and the version of the operating system or the application managed by the version file.

20. The information processing system according to claim 16, wherein selection of whether or not to validate the file data transferred to the mobile terminal using the close proximity wireless communication unit is enabled, and only the data for which validation is selected is loaded and validated.
